(19) United States
(12) Patent Application Publication
(10) Pub. No.: US 2026/0116654 A1
(43) Pub. Date: Apr. 30, 2026

(54) AUTONOMOUS REFUSE VEHICLE WITH ROBOTIC ARM STATE CONTROL ARCHITECTURE

(71) Applicant: Oshkosh Corporation, Oshkosh, WI (US)

(72) Inventors: Brendan Chan, Oshkosh, WI (US); Roberto Santana Blanco, Oshkosh, WI (US); Leo van Kampen, Conestogo (CA); Vince Schad, Oshkosh, WI (US); Joseph Wigle, Oshkosh, WI (US); Todd Cannon, Oshkosh, WI (US)

(73) Assignee: Oshkosh Corporation, Oshkosh, WI (US)

(21) Appl. No.: 19/368,709

(22) Filed: Oct. 24, 2025

Related U.S. Application Data
(60) Provisional application No. 63/711,789, filed on Oct. 25, 2024.

(51) Int. Cl. B65F 3/02

(52) U.S. Cl. CPC B65F 3/02; B65F 2003/0279

(57) ABSTRACT

An autonomous refuse vehicle can include a chassis, a body assembly, a drive motor, a lift system, and a controller. The controller can include one or more memory devices storing instructions thereon. The instructions can, when executed by one or more processors, cause the one or more processors to receive one or more first signals to indicate a first state of the lift system, receive one or more second signals to indicate a second state of the drive motor, and determine a control action for the lift system with respect to a refuse container detected as being proximate to the body assembly.

### CROSS-REFERENCE TO RELATED APPLICATIONS

This application claims the benefit of and priority to U.S. Provisional Patent Application No. 63/711,789, filed Oct. 25, 2024, the entire contents of which are incorporated by reference herein.

### BACKGROUND

The present disclosure relates to a system architecture for an autonomous refuse vehicle.

### SUMMARY

An exemplary embodiment of the present disclosure relates to an autonomous refuse vehicle. The autonomous refuse vehicle can include a body. The body can define a shape of the autonomous refuse vehicle. The autonomous refuse vehicle can include a chassis. The chassis can support the body. The autonomous refuse vehicle can include a drive motor. The drive motor can move the autonomous refuse vehicle. The autonomous refuse vehicle can include a robotic arm. The robotic arm can be movably coupled with the body. The robotic arm can grab one or more refuse containers. The autonomous refuse vehicle can include a controller. The controller can be electrically coupled with the drive motor and the robotic arm. The controller can include one or more memory devices. The one or more memory devices can store instructions thereon. The instructions can, when executed by one or more processors, cause the one or more processors to receive, via a controller area network, from a first module coupled with the robotic arm, one or more first signals to indicate a first state of the robotic arm. The instructions can cause the one or more processors to receive, via the controller area network, from a second module coupled with the drive motor, one or more second signals to indicate a second state of the drive motor. The instructions can cause the one or more processors to determine, based at least on the first state and the second state, a control action for the robotic arm with respect to a refuse container detected as being proximate to the autonomous refuse vehicle.

In some embodiments, the robotic arm can be controllable by a joystick of the autonomous refuse vehicle and by the controller. One or more inputs to the robotic arm, from the joystick, can interrupt one or more second inputs provided to the robotic arm by the controller.

In some embodiments, the instructions can cause the one or more processors to receive, from the first module, an indication of a detection of the refuse container. The first module can detect and classify objects based on data captured by one or more cameras disposed on the autonomous refuse vehicle. The first state of the robotic arm can reflect (i) the detection of the refuse container and (ii) a position of the robotic arm relative to the refuse container.

In some embodiments, the instructions can cause the one or more processors to monitor, based on subsequent information provided by at least one of the first module or the second module, changes to the first state and the second state. The instructions can cause the one or more processors to update, based on the changes to the first state and the second state, the control action for the robotic arm.

Another exemplary embodiment relates to an autonomous refuse vehicle. The autonomous refuse vehicle can include a chassis. The autonomous refuse vehicle can include a body assembly. The body assembly can be supported by the chassis. The body assembly can define a refuse compartment. The autonomous refuse vehicle can include a drive motor. The drive motor can be coupled to the chassis. The drive motor can drive one or more tractive elements to move the autonomous refuse vehicle. The autonomous refuse vehicle can include a lift system. The lift system can be movably coupled with the body assembly. The lift system can engage one or more refuse containers. The lift system can deposit contents of the one or more refuse containers into the refuse compartment. The autonomous refuse vehicle can include a controller. The controller can be electrically coupled with the drive motor and the lift system. The controller can include one or more memory devices storing instructions thereon. The instructions can, when executed by one or more processors, cause the one or more processors to receive, via a controller area network, from a first module coupled with the lift system, one or more first signals to indicate a first state of the lift system. The instructions can cause the one or more processors to receive, via the controller area network, from a second module coupled with the drive motor, one or more second signals to indicate a second state of the drive motor. The instructions can cause the one or more processors to determine, based at least on the first state and the second state, a control action for the lift system with respect to a refuse container detected as being proximate to the body assembly.

Another exemplary embodiment relates to a control system. The control system can be for an autonomous refuse vehicle. The control system can include one or more memory devices. The one or more memory devices can store instructions thereon. The instructions can, when executed by one or more processors, cause the one or more processors to receive, from a first module coupled with a lift system of the autonomous refuse vehicle, one or more first signals to indicate a first state of the lift system. The instructions can cause the one or more processors to receive, from a second module coupled with a drive motor of the autonomous refuse vehicle, one or more second signals to indicate a second state of the drive motor. The instructions can cause the one or more processors to determine, based at least on the first state and the second state, a control action for the lift system with respect to a refuse container detected as being proximate to the autonomous refuse vehicle.

Another exemplary embodiment relates to a system. The system can an autonomous refuse vehicle. The autonomous refuse vehicle can include a chassis. The autonomous refuse vehicle can include a body assembly. The body assembly can be supported by the chassis. The body assembly can define a refuse compartment. The autonomous refuse vehicle can include a drive motor. The drive motor can be coupled to the chassis. The drive motor can move the autonomous refuse vehicle. The autonomous refuse vehicle can include a lift system. The lift system can be movably coupled with the body assembly. The lift system can grab one or more refuse containers. The system can include a controller. The controller can be electrically coupled with the drive motor and the lift system. The controller can include one or more memory devices. The one or more memory devices can store instructions thereon. The instructions can, when executed by one or more processors, cause the one or more processors to receive, via a controller area network, from a first module coupled with the lift system, one or more first signals to indicate a first state of the lift system. The instructions can cause the one or more processors to receive, via the controller area network, from a second module coupled with the drive motor, one or more second signals to indicate a second state of the drive motor. The instructions can cause the one or more processors to determine, based at least on the first state and the second state, a control action for the lift system with respect to a refuse container detected as being proximate to the autonomous refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment;

FIG. 2 is a perspective view of a chassis of the vehicle of FIG. 1, according to an exemplary embodiment;

FIG. 3 is a perspective view of the vehicle of FIG. 1 configured as a front-loading refuse vehicle, according to an exemplary embodiment;

FIG. 4 is a left side view of the front-loading refuse vehicle of FIG. 3 configured with a tag axle, according to an exemplary embodiment;

FIG. 5 is a block diagram of a system to control one or more operations of a vehicle, according to an exemplary embodiment;

FIG. 6 is a block diagram of a system architecture for the system of FIG. 5, according to an exemplary embodiment;

FIG. 7 is a block diagram of a system architecture for the system of FIG. 5, according to an exemplary embodiment;

FIG. 8 is a block diagram of a system architecture for the system of FIG. 5, according to an exemplary embodiment;

FIG. 9 is a flow diagram of a method to control one or more operations of a vehicle, according to an exemplary embodiment; and

FIG. 10 is a block diagram of a system to execute control decisions, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to an autonomous driving system for a refuse vehicle, configured to monitor and respond to various operational states of the refuse vehicle through signals received from onboard modules. These modules may include sensors, state machines, and other components that detect and communicate the status (e.g., states) of specific vehicle elements. For instance, a drive motor module may indicate whether the vehicle is in motion, while a lift system module may signal whether a lift arm is stowed or actively extending toward a refuse container. By implementing independent systems for monitoring and control, the autonomous driving system enhances operational redundancy, thereby improving reliability and safety in refuse collection operations.

The system is further configured to interpret changes in vehicle states to initiate corresponding operations. For example, a transition to a stopped vehicle state, combined with detection of a refuse container, may automatically trigger activation of the lift system to engage with the refuse container. Upon completion of the collection cycle—such as when the lift arm is indicated as being in a stowed state and the refuse container is detected as having been returned to the curb—the system may interpret these conditions as a state change that triggers the vehicle to resume driving. This dynamic response to state transitions enables the refuse vehicle to operate autonomously and efficiently, reducing the need for manual intervention and improving overall system performance.

### Overall Vehicle

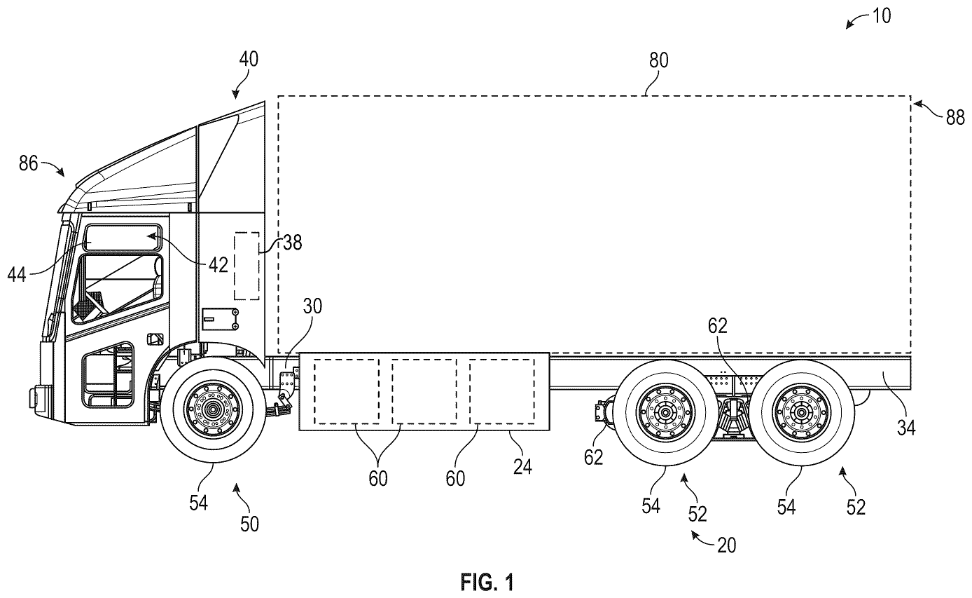

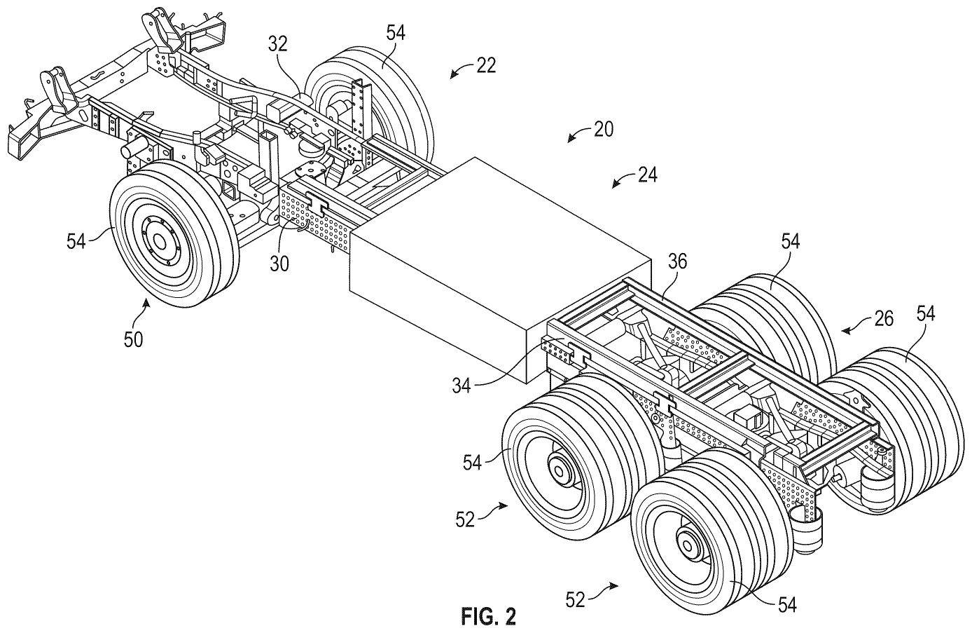

Referring to FIGS. 1 and 2, a vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10. The body of the vehicle 10 can define a shape or dimension of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front-end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

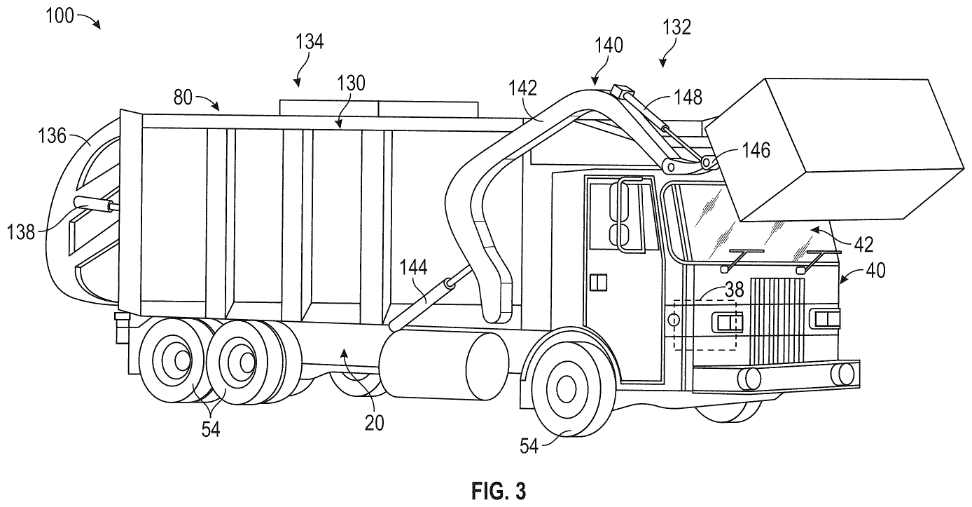

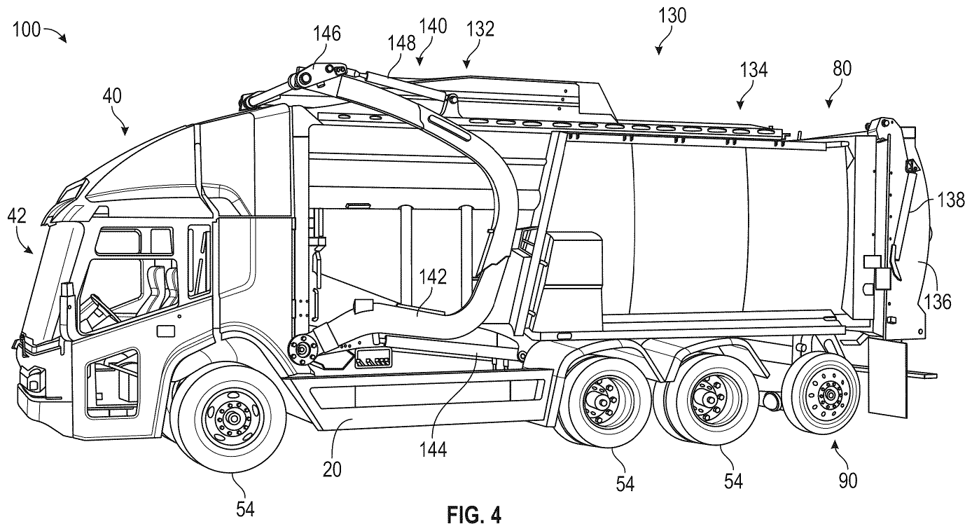

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, the vehicle 10 may be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-4 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

The vehicle 10 includes a controller 38 that is configured to operate any of the motors, actuators, components, implements, and/or elements of the various vehicles described herein. For example, the application kit 80 may be controllable by the controller 38. In some embodiments, the controller 38 may receive sensory input from sensors disposed on the vehicle 10. The controller 38 may generate control signals to operate any of the vehicle components described herein. For example, the controller 38 may generate control signals to control the drive motors 62.

### Front-loading Refuse Vehicle

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck).

As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

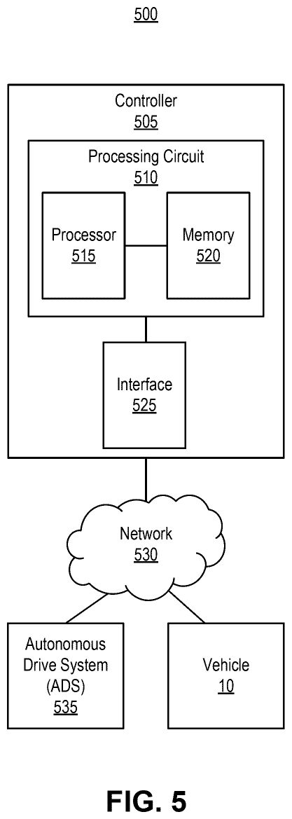

FIG. 5 depicts a block diagram of a an autonomous or semi-autonomous control system, shown as system 500, according to an exemplary embodiment. In some embodiments, the system 500 includes one or more systems, devices, and/or components described herein. For example, as shown in FIG. 5, the system 500 includes the vehicle 10. In some embodiments, the system 500 may include at least one of the various vehicles and/or one or more systems, devices, components, and/or assemblies thereof. In some embodiments, the system 500 may include at least one controller 505 and at least one autonomous drive system (shown as ADS 535). The controller 505, the vehicle 10, and the ADS 535 may be communicably coupled with one another via network 530. For example, the controller 505 may transmit one or more signals to the vehicle 10, via the network 530. As another example, the network 530 may facilitate communication between the ADS 535 and the controller 505. In some embodiments, the network 530 may include at least one of a controller area network (CAN), a wide area network (WAN), a local area network (LAN), a cellular network, the internet, Wi-Fi, and/or other possible networks.

In some embodiments, the various components in the system 500 can be implemented via hardware (e.g., circuitry), software (e.g., executable code), or any combination thereof. Systems, devices, and components, in FIG. 5, can be added, deleted, integrated, separated, and/or rearranged. For example, a first component and a second component may be combined as a single component (e.g., the controller 505 and/or the ADS 535 may be disposed on the vehicle 10 as part of at least one edge computing device, and/or integrated with one another such that the controller 505 implements the ADS 535 and/or vehicle functions of the vehicle 10). As another example, a first component may be separated into two or more discrete components.

In some embodiments, the ADS 535 may refer to and/or include one or more of circuity, components, hardware, and/or other possible electrical devices to perform autonomous control of the vehicle 10. For example, the ADS 535 may include and/or communicate with one or more sensors to detect objects near the vehicle 10. The ADS 535 may control and/or facilitate control of the vehicle 10 to navigate the vehicle 10. For example, the ADS 535 may facilitate control of the drive motors 62 to move the vehicle 10. As another example, the ADS 535 may facilitate control of one or more steering components of the vehicle 10. In some embodiments, the ADS 535 may be executed by and/or implemented by the controller 505. For example, the ADS 535 may represent one or more instructions and/or executable code and the controller 505 may be configured to execute the instructions to perform the operations of the ADS 535.

In some embodiments, the controller 505 may include at least one processing circuit 510 and at least one interface 525. The processing circuit 510 may be communicably coupled with the interface 525. For example, the processing circuit 510 may transmit information to and/or receive information from the interface 525. In some embodiments, the interface 525 may facilitate communication for the processing circuit 510 with one or more discrete and/or separate components. For example, the interface 525 may communicably couple the processing circuit 510 with the network 530.

In some embodiments, the processing circuit 510 may include at least one processor 515 and memory 520. In some embodiments, the processing circuit 510 and/or one or more components thereof (e.g., the processors 515 and memory 520) may perform similar functionality to that of the controller 505 and/or one or more components thereof. For example, memory 520 may store programming logic that, when executed by the processors 515, cause the processors 515 to control various amounts of fluid power provided by hydraulic system. In some embodiments, the processors 515 may be implemented as a general-purpose processor, an application specific integrated circuit (ASIC), one or more field programmable gate arrays (FPGAs), a group of processing components, or other suitable electronic processing components.

In some embodiments, memory 520 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 520 may be or include volatile memory or non-volatile memory. Memory 520 may include database components, object code components, script components, or any other type of information structure for supporting the various activities and information structures described in the present application. According to an exemplary embodiment, memory 520 is communicably connected to the processors 515 via the processing circuit 510 and memory 520 includes computer code for executing (e.g., by the processing circuit 510 and/or the processors 515) one or more processes described herein.

In some embodiments, the interface 525 may include at least one of network communication devices, network interfaces, and/or other possible communication interfaces. The interface 525 may include wired or wireless communications interfaces (e.g., jacks, antennas, transmitters, receivers, transceivers, wire terminals, etc.) for conducting data communications with various systems, devices, and/or components described herein. The interface 525 may be direct (e.g., local wired or wireless communications) and/or via a communications network. For example, the interface 525 may include an Ethernet card and port for sending and receiving data via an Ethernet-based communications link or network. The interface 525 may also include a Wi-Fi transceiver for communicating via a wireless communications network. The interface 525 may include a power line communications interface. The interface 525 may include an Ethernet interface, a USB interface, a serial communications interface, and/or a parallel communications interface.

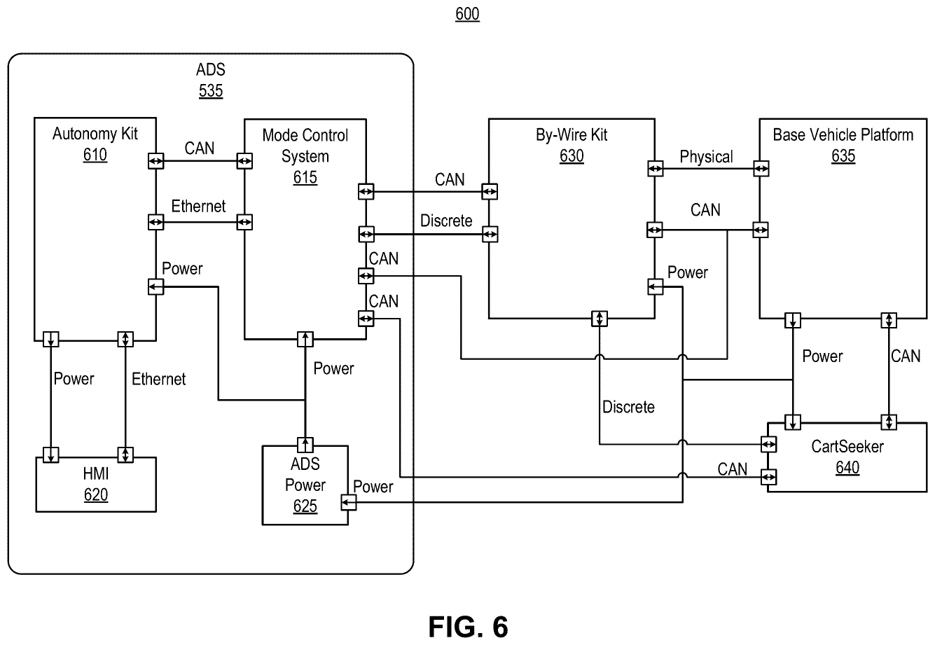

FIG. 6 depicts a block diagram of a system architecture 600, according to an exemplary embodiment. In some embodiments, at least one of the various systems, devices, and/or components described herein may implement and/or execute at least a portion of the system architecture 600. For example, the controller 505 may implement one or more elements and/or components of the system architecture. Additionally, and/or alternatively, the system architecture 600 may include at least one of the various systems, devices, and/or components described herein. For example, the system architecture 600 may include the ADS 535.

As shown in FIG. 6, the ADS 535 includes an autonomy kit 610, a mode control system 615, a human-machine interface (HMI) 620, and an ADS power 625. The autonomy kit 610 may refer to and/or include one or more components and/or hardware to facilitate control of the vehicle 10. For example, the autonomy kit 610 may include digital signal processors, logic gates, rules based engines, central processing units, and/or other possible hardware. The mode control system 615 may refer to and/or include one or more components and/or hardware to facilitate switching between one or modes of the vehicle. For example, the mode control system 615 may switch the vehicle 10 from a collection mode to a travel mode. As another example, the mode control system 615 may switch the vehicle 10 from a compacting mode to a return home mode.

In some embodiments, the HMI 620 may facilitate communication between the ADS 535 and an operator of the vehicle 10. For example, the HMI 620 may present, via one or more user interfaces, information to the operator. As another example, the HMI 620 may provide information, received via the user interfaces, to the ADS 535. In some embodiments, the ADS power 625 may provide power to one or more components of the ADS 535. The ADS power 625 may forward power from one or more energy storage devices. For example, the ADS power 625 may provide power from one or more batteries of the vehicle 10.

In some embodiments, the system architecture 600 includes a bi-wire kit 630, a base vehicle platform 635, and a cartseeker 640. The bi-wire kit 630 may refer to and/or include one or more terminals, ports, interfaces, and/or junctions to communicably couple the ADS 535 with one or more components of the system architecture 600. For example, the bi-wire kit 630 may include one or more of switches, gateways, and/or bridges. In some embodiments, the base vehicle platform 635 may refer to and/or include one or more components and/or assemblies of the vehicle 10. For example, the base vehicle platform 635 may include the lift assembly 140. As another example, the base vehicle platform 635 may include one or more controllable elements (e.g., actuators, pumps, gauges, etc.) that move or otherwise adjust elements and/or components of the vehicle 10. In some embodiments, the base vehicle platform 635 may refer to and/or include at least one robotic arm and/or at least one lift system.

In some embodiments, the cartseeker 640 may include one or more components to facilitate detection of one or more objects. For example, the cartseeker 640 may include an application that performs object detection based on image data collected by one or more cameras. As another example, the cartseeker 640 may include an application that performs object detection based on information collected by one or more sensors. As another example, the cartseeker 640 may classify objects. In some embodiment, the cartseeker 640 may include one or more of machine learning models, object detectors, generative pre-trained transformers, and/or machine vision systems. The cartseeker 640 may implement, enable, or otherwise execute at least one object detection system. For example, enablement of an object detection system (by the cartseeker 640) may occur while the vehicle 10 is in motion (e.g., moving) and/or prior to movement of a robotic arm. The cartseeker 640 may also transmit command and/or control signals to the ADS 535 and/or the base vehicle platform 635, such as to provide autonomous or semi-autonomous control of the lift system.

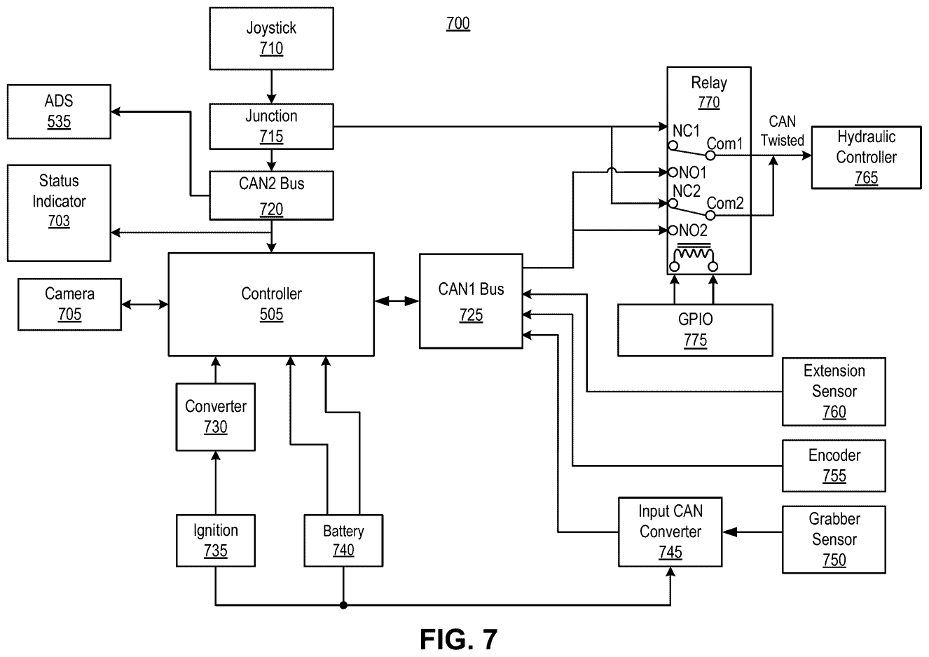

FIG. 7 depicts a block diagram of a system architecture 700, according to an exemplary embodiment. In some embodiments, the system architecture 700 may illustrate and/or represent communication between one or more of the various systems, devices, components, and/or applications described herein. Additionally or alternatively, the system architecture 700 may illustrate and/or represent implementation of one or more systems, devices, components, and/or applications described herein. For example, the cartseeker 640 may include one or more components of the system architecture 700.

As shown in FIG. 7, the system architecture 700 includes the ADS 535 and the controller 505. In some embodiments, the system architecture 700 may include at least one status indicator 703, at least one camera 705, at least one joystick 710, at least one junction 715, at least one CAN2 bus 720, at least one CAN1 bus 725, at least one converter 730, at least one ignition 735, at least one battery 740, at least one Input CAN converter 745, at least one grabber sensor 750, at least one encoder 755, at least one extension sensor 760, at least one hydraulic controller 765, at least one relay 770, and/or at least one general purpose input/output (GPIO) 775.

In some embodiments, the status indicator 703 may include one or more visual indicators (e.g., lights, light emitting diodes, etc.), display devices (e.g., screens, monitors, etc.), audible indicators (e.g., speakers, etc.), haptic devices, and/or other discernable indicators. In some embodiments, the status indicator 703 may be disposed in the vehicle 10. For example, the status indicator 703 may be located in the cab 40 of the vehicle 10. As another example, the status indicator 703 may be presented by the HMI 620. In some embodiments, the camera 705 may include at least one of sensors, image devices, recording devices, measuring instruments, and/or telemetric devices. For example, the camera 705 may include a stereo camera. As another example, the camera 705 may include a LIDAR sensor.

In some embodiments, the joystick 710 may refer to and/or include one or more input/output devices. For example, the joystick 710 may include tactile buttons, levers, handles, a mouse, a keyboard, a number pad, and/or other possible input devices. In some embodiments, the joystick 710 may control operation of one or more elements and/or assemblies of the vehicle 10. For example, an operator of the vehicle 10 may maneuver and/or otherwise operate the joystick 710 to cause a corresponding movement of a grabber assembly of the vehicle 10. As another example, the operator of the vehicle 10 may operate the joystick 710 to dump refuse or other deposit refuse into the refuse compartment 130. As shown in FIG. 7, the joystick 710 may provide one or more signals to the junction 715 and the relay 770. For example, the joystick 710 may provide one or more control signals (e.g., signals that facilitate movement and/or control of one or more elements of the vehicle 10) to the junction 715. The relay 770 may receive, via the junction 715, the control signals as one or more inputs which cause the relay 770 to either open and/or close. For example, the control signals, provided by the joystick 710, may override and/or interrupt one or more signals provided by the ADS 535. Stated otherwise, the relay 770 may isolate and/or prevent inputs, from the ADS 535, from controlling operation of the vehicle 10 and/or one or more portions thereof.

As shown in FIG. 7, the junction 715 may be coupled with the controller 505 via the CAN2 bus 720. For example, the CAN2 bus 720 may carry one or more messages to and/or from the junction 715. As another example, the CAN2 bus 720 may communicably couple the ADS 535 with the controller 505. The CAN2 bus 720 may provide one or more signals to the status indicator 703. For example, the CAN2 bus 720 may provide vehicle status signals to the status indicator 703, which may cause the status indicator 703 to present one or more sets of information.

The controller 505 may be communicably coupled with the camera 705, the converter 730, the battery 740, and the CAN1 bus 725. For example, the converter 730 may be directly coupled with the controller 505 such that one or more outputs of the converter 730 are provided as inputs to the controller 505. As another example, the ignition 735 may provide one or more inputs to the controller 505, via the converter 730. In some embodiments, the battery 740 may provide power and/or electrical energy to the controller 505.

In some embodiments, the CAN1 bus 725 may communicably couple the controller 505 with the relay 770, the GPIO 775, the extension sensor 760, the encoder 755, and/or the input CAN converter 745. For example, the controller 505 may detect a status of the relay 770 based on one or more signals carried by the CAN1 bus 725. As another example, the controller 505 may receive sensor data, via the CAN1 bus 725, from the extension sensor 760. In some embodiments, the extension sensor 760 may provide one or more sets of information that represent and/or indicate positional and/or alignment information of one or more elements and/or assemblies of the vehicle 10. For example, the extension sensor 760 may provide information that indicates a position of the lift arms 142. In some embodiments, the grabber sensor 750 may provide one or more sets of information that represent and/or indicate a status of regarding the collection of refuse containers. For example, the grabber sensor 750 may provide information regarding whether a grabber assembly of the vehicle 10 has grabbed and/or otherwise secured a refuse container.

In some embodiments, the GPIO 775 may provide one or more slots and/or ports for which one or more components and/or elements may be added to and/or included in the system architecture 700. For example, the GPIO 775 may facilitate the addition of one or more sensors to the system architecture 700. In some embodiments, the GPIO 775 may implement a cartseeker monitoring module (e.g., a controller 505 monitoring module) that is configured to provide an operational status of the cartseeker system to the relay, and thereby facilitate switching between automatic and manual control functions (e.g., selectively coupling the joystick 710 to the hydraulic controller 765 in the event of a failure/fault of the controller 505 and/or the cartseeker system).

In some embodiments, the relay 770 can disconnect and/or otherwise isolate the hydraulic controller 765 such that operation of a hydraulic system can be halted and/or prevented. For example, the relay 770 can activate an e-stop which halts operation of one or more elements and/or assemblies of the vehicle 10. As another example, the relay 770 can forward or otherwise transmit one or more signals, from the joystick 710, to the hydraulic controller 765 such that operation of the hydraulic system reflects the signals generated and/or provided by the joystick 710 (e.g., a manual control function). Additionally, and/or alternatively, the joystick 710 may be directly coupled with the hydraulic controller 765, via the relay 770, such that the joystick 710 may communicate with and/or control the hydraulic controller 765 even in instances where power is lost and/or power is low. Stated otherwise, the joystick 710 may be able to communicate with the hydraulic controller 765 even during a vehicle power outage.

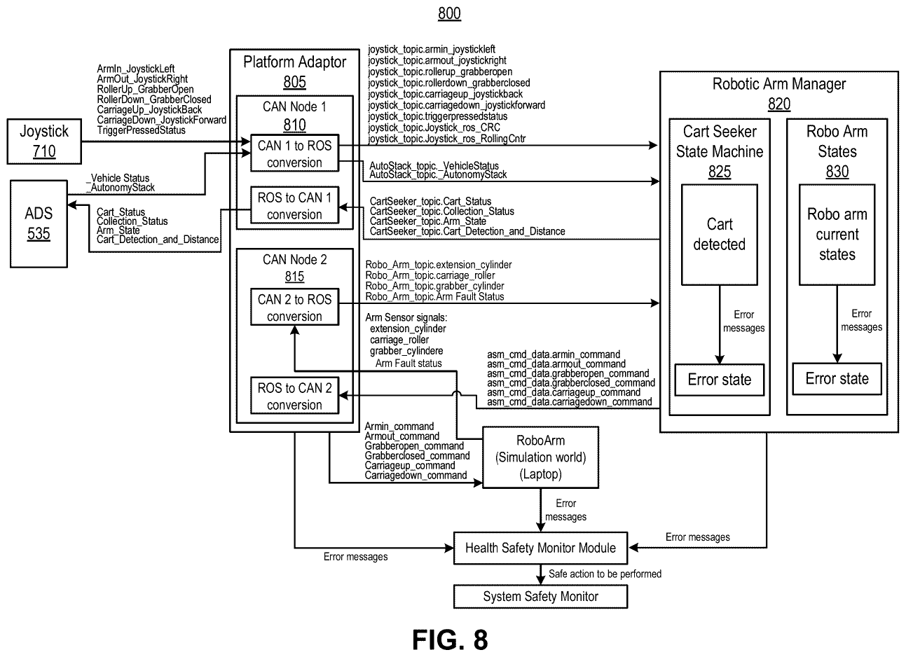

FIG. 8 depicts a block diagram of another system architecture 800 for an autonomous or semi-autonomous refuse vehicle, according to an exemplary embodiment. The system architecture 800 illustrates transmission and/or conversion of one or more signals between elements/components. For example, as shown in FIG. 8, a platform adapter 805 may forward one or more signals, from the joystick 710, to a robotic arm manager 820. As another example, the platform adapter 805 may provide one or more signals, from the robotic arm manager 820, to the ADS 535. In some embodiments, the signals and/or information exchanged between components and/or elements of the system architecture 800 may refer to and/or include status signals and/or state tracking signals. For example, the robotic arm manager 820 may transmit one or more status signals, which indicate a status of a robotic arm of the vehicle 10. As another example, the robotic arm manager 820 may provide a state signal, which indicates a state of the cartseeker 640.

In some embodiments, the robotic arm manager 820 may refer to and/or include at least one of a module, an application, an executable file, executable code, firmware, software, and/or instructions that, when executed by the processing circuit 510, cause the processing circuit 510 to carry out one or more functions and/or actions of the robotic arm manager 820. In some embodiments, the platform adapter 805 may refer to and/or include at least one of an application, an executable file, executable code, firmware, software, and/or instructions that, when executed by the processing circuit 510, cause the processing circuit 510 to carry out on or more functions and/or actions of the platform adapter 805.

As shown in FIG. 8, the platform adapter 805 includes a CAN node 810 and a CAN node 815. In some embodiments, the CAN node 810 may represent the CAN1 bus 725 and the CAN node 815 may represent the CAN2 bus 720. As shown in FIG. 8, the CAN node 810 may facilitate communication between the robotic arm manager 820, the joystick 710, and the ADS 535. For example, the CAN node 810 may provide one or more cart_detection_and_distance signals to the ADS 535. As shown in FIG. 8, the CAN node 815 may facilitate communication between the robotic arm manager 820 and one or more safety elements (e.g., Roboarm, health safety monitor module, and system safety monitor). In some embodiments, the safety elements may implement and/or include the relay 770.

As shown in FIG. 8, the robotic arm manager 820 includes a cart seeker state machine 825 and a robo arm states 830, which may be implemented as separate control modules and/or control circuits. In some embodiments, the cart seeker state machine 825 may track one or more states of the cartseeker 640. For example, the cart seeker state machine 825 may track whether the cartseeker 640 is active and/or disabled. As another example, the cart seeker state machine 825 may track whether the cartseeker 640 has detected one or more refuse containers. In some embodiments, the robo arm states 830 may track one or more states of the robotic arm. For example, the robo arm states 830 may track when the robotic arm is in a deployed position. As another example, the robo arm states 830 may track when the robotic arm has grabbed, collected, captured, and/or otherwise secured a refuse container.

While FIG. 8 illustrates example signal types, signal names, and/or contents of the signals, this is for illustrative purposes only and is in no way limiting. For example, the robotic arm manager 820 may transmit less than and/or more than the number of signals illustrated in FIG. 8. As another example, the robotic arm manager 820 may transmit different signals relative to the signals illustrated in FIG. 8.

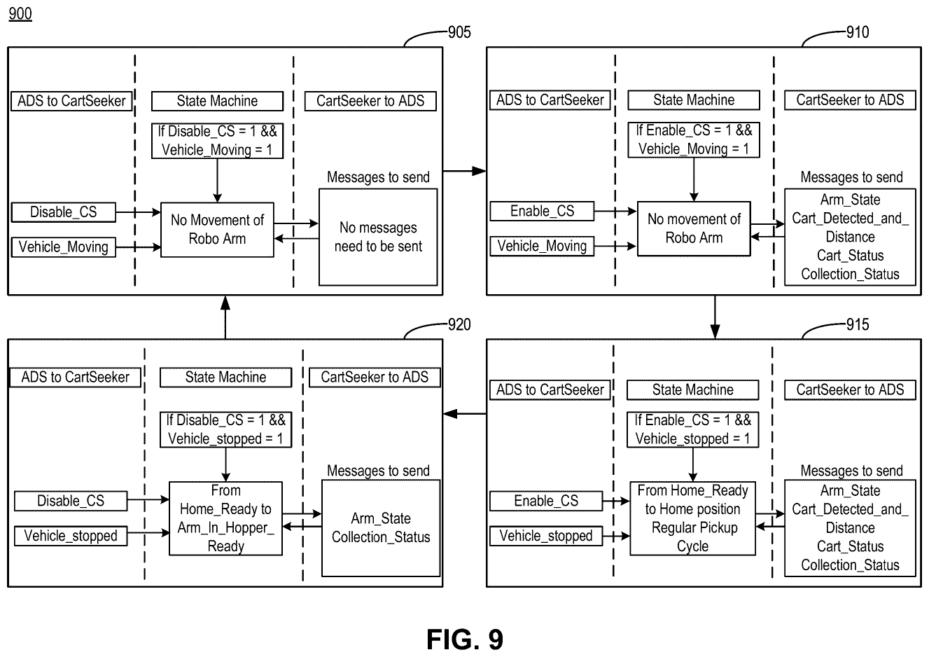

FIG. 9 is a flow diagram of a method 900 for determining and executing control states for an autonomous or semi-autonomous refuse vehicle, according to an exemplary embodiment. In some embodiments, at least one of the various systems, devices, components, and/or elements described herein may implement the method 900 and/or one or more portions thereof. While the method 900 may be described in a given order and/or pattern, this is for illustrative purposes only and is in no way limiting. For example, one or more aspects and/or portions of the method 900 may be switched, omitted, reordered, reproduced, replicated, skipped, repeated, and/or otherwise changed.

In some embodiments, decision block 905 may correspond to a transit operation state in which the CartSeeker system for the vehicle 10 is disabled (Disable_CS=1) and the vehicle 10 is moving (Vehicle_moving=1). This state ensures that the lift system, including the robotic arm or the lift arm, remains inactive or idle during vehicle motion. Decision block 905 can be a protective condition that is designed to prevent any lift system activity while the vehicle is in transit, thereby avoiding potential hazards or unintended interactions. Additionally, because the CartSeeker is disabled and no container engagement is expected during movement, no messages are sent from the CartSeeker to the autonomous driving system (ADS).

In some embodiments, at decision block 905, a state machine may receive one or more signals. For example, the state machine may receive signals from the ADS 535. In some embodiments, the state machine may include the robotic arm manager 820 and/or one or more portions thereof. The state machine may receive one or more signals that indicate various statuses of the vehicle. For example, the state machine may receive a signal which indicates that the vehicle 10 is moving. The state machine may receive one or more signals to control and/or adjust operation of the cartseeker 640 responsive to the one or more signals. For example, the state machine may receive a signal which disables the cartseeker 640 or otherwise indicates that the cartseeker 640 is to remain disables.

As shown in FIG. 9, at decision block 905, the state machine executes logic and/or one or more truth tables to determine corresponding actions. For example, the state machine may utilize the status of the cartseeker (e.g., Disable_CS=1) and the status of the vehicle (e.g., Vehicle_Moving=1) to determine that no actions are to be taken by the robotic arm, so as to prevent movement of the robotic arm (e.g., the lift system) when the refuse vehicle is in transit at highway speeds, between neighborhoods, etc.). Additionally, or alternatively, the state machine may determine whether to transmit one or more signals to the cartseeker 640. As shown in FIG. 9, there are no messages to be sent based on the determination that there will be no movement of the robotic arm.

In some embodiments, the state machine may implement logic and/or rules based processing to identify one or more instances for which to perform actions or operations. For example, the state machine may implement logic to identify instances to operate or otherwise control a robotic arm. As another example, the state machine may implement logic to identify instances to operate the drive motor.

In some embodiments, decision block 910 may correspond to an object detection initiation state in which the CartSeeker system is enabled (Enable_CS=1) and the vehicle is moving (Vehicle_moving=1). This state may occur during active collection route operations, where the vehicle is in motion and the CartSeeker is actively scanning for refuse containers. The system initiates object detection (e.g., enables CartSeeker) to identify containers along the route and to assist in aligning the vehicle for pickup. During this state, the CartSeeker sends messages to the autonomous driving system (ADS) that include operational data such as the state of the lift system or robotic arm, whether a refuse container has been detected, the status of the container (e.g., resting, picked up, etc.), and the collection status (e.g., pending, in progress, complete). This information supports real-time decision-making and prepares for engagement once the vehicle reaches a suitable stop point. The decision block 910 may be initiated responsive to the vehicle 10 being within a certain range or distance from a collection site.

In some embodiments, at decision block 910, the state machine may receive a signal (which indicates a change in the status of the cartseeker 640, such as responsive to the refuse vehicle entering a neighborhood or beginning a refuse collection route within the neighborhood, business park, etc.) to begin monitoring for refuse containers along the route. For example, the state machine may receive a signal to enable (e.g., Enable_CS=1) the cartseeker 640. In some embodiments, the state machine may activate and/or enable the cartseeker 640 such that the cartseeker 640 begins to perform one or more actions. For example, enablement of the cartseeker 640 may cause the cartseeker 640 to perform object detection and/or object recognition. The state machine may prevent operation of the robotic arm (e.g., the lift system) during block 910 until a refuse container and/or a threshold alignment between the robotic arm and the refuse container has been identified (e.g., achieved, satisfied, etc.).

As shown in FIG. 9, at decision block 910, the cartseeker 640 returns one or more status signals to the ADS 535 such that the ADS 535 may execute one or more actions based on the status signals. For example, the cartseeker 640 may provide a status signal regarding the state of the robotic arm. As another example, the cartseeker 640 may provide a status signal regarding the status of a detected refuse container and/or cart. In some embodiments, the state machine may provide and/or otherwise forward one or more messages, from the cartseeker 640, to the ADS 535. Additionally, and/or alternatively the state machine may determine one or more control decisions regarding the robotic arm. For example, the state machine may use the inputs, from the ADS 535, as one or more logic factors.

In some embodiments, decision block 915 may correspond to a refuse collection state in which the CartSeeker system is still enabled (Enable_CS=1) and the vehicle is now stopped (Vehicle_stopped=1). Decision block 915 may correspond to the transition from object detection to preparation for container engagement. With the vehicle stationary, the CartSeeker provides detailed state information to the autonomous driving system (ADS), including the state of the lift system or robotic arm, the state of the detected refuse container, and the alignment between the vehicle and the container. Based on this data, the state machine determines whether conditions are suitable to initiate the collection routine. If alignment state and container state are confirmed, the system proceeds to activate the lift system for pickup.

In some embodiments, at decision block 915, the state machine may receive signals from the ADS 535. For example, the state machine may receive a signal indicating that the vehicle 10 has stopped (e.g., no longer moving). In some embodiments, the state machine may receive signals from the cartseeker 640. For example, the state machine may receive a signal indicating a relative position and/or distance between the vehicle 10 and a refuse container. As another example, the state machine may receive a signal indicating a position and/or configuration of a grabber arm (e.g., the lift system).

As shown in FIG. 9, at decision block 915, the state machine makes one or more decisions based on the inputs provided by the ADS 535 and the cartseeker 640 (e.g., to initiate a refuse collection operation using the robotic arm). For example, the state machine may make a control decision regarding a pickup cycle of the vehicle. As another example, the state machine may make a control decision regarding adjustment and/or realignment of the vehicle 10 relative to a refuse container. As another example, the state machine may execute one or more control signals responsive to receipt of the inputs.

In some embodiments, decision block 920 may correspond to the final state in the collection cycle, where the CartSeeker system is to be disabled (Disable_CS=1) and the vehicle remains stopped (Vehicle_stopped=1). Before disabling the CartSeeker, the state machine receives confirmation of key conditions: the lift system is in a stowed state, and the collection process is complete which indicates that the refuse has been deposited and the container has been returned to its original position. Once these conditions are verified, the CartSeeker is disabled, signaling the end of active container engagement. The autonomous driving system (ADS) then prepares the vehicle to transition to the next stop along the collection route.

In some embodiments, at decision block 920, the state machine may execute one or more control decisions based on changes to signals provided by the ADS 535 and/or the cartseeker 640, for example, to return the robotic arm to a transit position after performing a refuse collection operation, and to confirm the operating state (e.g., collection status, arm position, etc.) to the controller. For example, as shown in FIG. 9, the ADS 535 may provide a signal which indicates to disable the cartseeker 640 (e.g., Disable_CS=1) and that the vehicle is stopped (e.g., Vehicle_stopped=1). As another example, as shown in FIG. 9, the cartseeker 640 may provide a signal which indicates a status of the robotic arm (e.g., Arm_State) and/or to confirm that a collection operation has been completed (e.g., Collection_Status). In some embodiments, the state machine may execute logic decisions regarding control of the vehicle 10. For example, the state machine may execute a logic decision to determine whether to dump refuse into the hopper of the vehicle 10. As another example, the state machine may execute a logic decision to determine whether to return a refuse container to a location from which the refuse container was originally grabbed from.

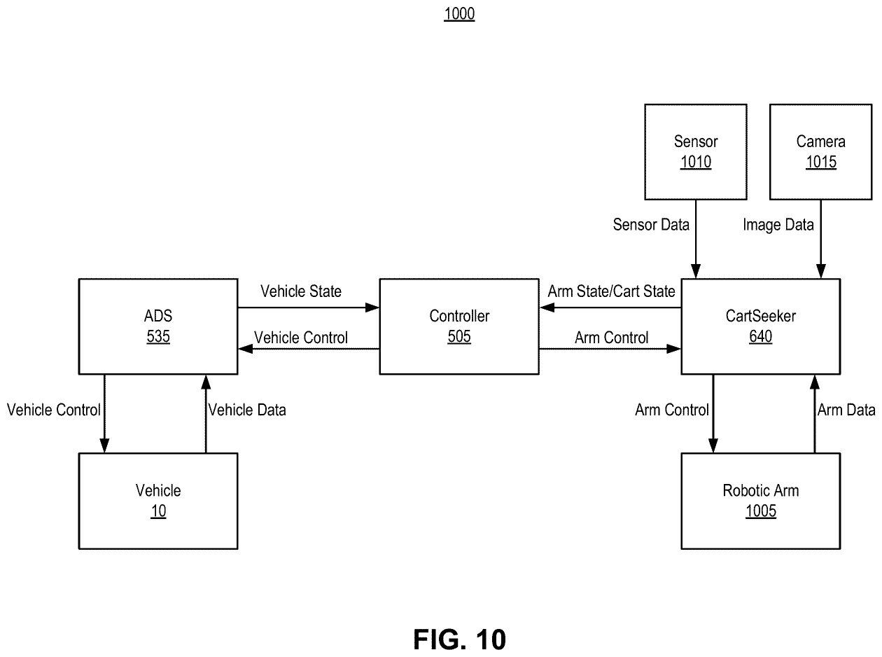

FIG. 10 is a block diagram of system 1000, according to an exemplary embodiment. The system 1000 may refer to and/or include at least one of the various systems, system architectures, devices, components, assemblies, and/or elements described herein. For example, as shown in FIG. 10, the system 1000 includes the vehicle 10, the controller 505, the ADS 535, and the cartseeker 640. In some embodiments, the system 1000 may include a systematic representation of communication between components. For example, the system 1000 may represent one or more decision blocks of the method 900. In some embodiments, the elements and/or components of the system 1000 may be discrete and/or separate components. For example, a first element of the system 1000 may be discrete hardware to hardware of a second element of the system 1000. In some embodiments, the elements and/or components of the system 1000 may be virtual and firmware based elements. For example, a first element of the system 1000 may represent software and/or other possible executable code that causes a computing device to perform the functions and/or actions of the first element.

In some embodiments, the system 1000 may include at least one robotic arm 1005, at least one sensor 1010, and/or at least one camera 1015. The robotic arm 1005 may refer to and/or include the robotic arm described herein. Additionally, and/or alternatively, the robotic arm 1005 may refer to or include a lift system. For example, the robotic arm 1005 may perform one or more actions associated with grabbing and/or otherwise securing refuse containers. The robotic arm 1005 may be movably coupled with one or more components of the vehicle 10. For example, the robotic arm 1005 may be movably coupled with the body of the vehicle 10.

In some embodiments, the sensor 1010 may include one or more of the various sensors described herein. The sensor 1010 may include one or more elements and/or devices that can detect objects. For example, the sensor 1010 may include LIDAR sensors and/or proximity sensors. As another example, the sensor 1010 may detect objects via infrared signals, sonar, radio waves, and/or ultrasonic waves. In some embodiments, the camera 1015 may include one or more of the various cameras and/or images devices described herein. The camera 1015 may include one or more elements and/or devices that can capture image and/or video data. For example, the camera 1015 may include stereo cameras, digital recording devices, video cameras, and/or other possible optical instruments.

In some embodiments, the sensor 1010 and/or the camera 1015 may be disposed and/or otherwise positioned on one or more locations of the vehicle 10. For example, the camera 1015 may be disposed on a front bumper of the vehicle 10. As another example, the sensor 1010 may be disposed on a side wall and/or side panel of the vehicle 10. In some embodiments, the sensor 1010 and the camera 1015 may collect, obtain, and/or otherwise capture data for use in detecting and/or recognizing objects. For example, the camera 1015 may provide image data to the cartseeker 640. The cartseeker 640 may execute one or more object detection functions to detect one or more objects in the image data. For example, the cartseeker 640 may detect one or more refuse containers in the image data.

In some embodiments, the cartseeker 640 may determine relative distances and/or relative positions between objects. For example, the cartseeker 640 may use sensor data, from the sensor 1010, to determine a relative distance between the vehicle 10 and a refuse container (e.g., a detected object). As another example, the cartseeker 640 may use sensor data to determine a position and/or an alignment of the vehicle 10 relative to the refuse container. The cartseeker 640 may determine the alignment of the vehicle 10 with respect to one or more components of the vehicle 10. For example, the cartseeker 640 may determine a relative alignment between the robotic arm 1005 and the refuse container. Stated otherwise, the cartseeker 640 may determine whether the robotic arm 1005 may be moved and/or otherwise operated such that the robotic arm 1005 may reach the refuse container. Additionally or alternatively, the alignment between the robotic arm 1005 and the refuse container may refer to and/or include how the robotic arm 1005 is positioned, in space, relative to the refuse container.

In some embodiments, the cartseeker 640 may communicate with and/or otherwise exchange messages with the robotic arm 1005. For example, the cartseeker 640 may provide one or more control signals to cause movement and/or operation of the robotic arm 1005. In some embodiments, the cartseeker 640 may receive and/or monitor telematic data associated with the robotic arm 1005. For example, the cartseeker 640 may monitor changes in location of the robotic arm 1005 to determine one or more states of the robotic arm 1005. As another example, the cartseeker 640 may monitor movement of the robotic arm 1005 to determine when to execute one or more commands. As another example, the cartseeker 640 may utilize subsequent information and/or information received from one or more modules to monitor changes to at least one of the states described herein.

In some embodiments, the cartseeker 640 may provide one or more signals to the controller 505. For example, the cartseeker 640 may provide Arm State signals. As another example, the cartseeker 640 may provide Cart State signals. In some embodiments, the cartseeker 640 may provide at least one of the various signals illustrated in FIG. 8. The cartseeker 640 may provide one or more signals to the controller 505 that serve as logic variables and/or logic inputs. For example, the controller 505 may execute one or more truth functions and/or IF logic based on the Arm State and/or the Cart state.

In some embodiments, the controller 505 may receive one or more sets of information from the ADS 535. For example, the controller 505 may receive a Vehicle State signal. The Vehicle State signal may refer to and/or include one or more statuses of the vehicle 10. For example, the Vehicle State signal may represent whether the vehicle 10 is moving and/or stationary. As another example, the Vehicle State signal may represent a speed of the vehicle 10.

In some embodiments, the controller 505 may determine one or more control actions based on the data provided by the cartseeker 640 and the ADS 535. For example, the controller 505 may perform the method 900 and/or one or more decision blocks thereof based on the information provided by the ADS 535 and the cartseeker 640. For example, the controller 505 may determine when to initiate a collection cycle, by the robotic arm 1005, based on the Vehicle State, the Arm State, and the Cart State. As another example, the controller 505 may determine when to dump (e.g., control action) refuse into the refuse compartment 130 of the vehicle 10. In some embodiments, the controller 505 may update and/or otherwise modify one or more control actions. For example, the controller 505 may update a control action to cause one or more elements of the vehicle 10 to perform given actions. As another example, the controller 505 may replace a first control action with a second control action.

In some embodiments, the controller 505 may provide one or more control signals to the ADS 535 and the cartseeker 640. For example, as shown in FIG. 9, the controller 505 provides a Vehicle Control signal to the ADS 535 which ultimately may be used to operate and/or maneuver the vehicle 10. As another example, as shown in FIG. 9, the controller 505 provides an Arm Control signal to the cartseeker 640 which ultimately may be used to operate and/or maneuver the robotic arm 1005. In some embodiments, the controller 505 may execute one or more control signals to enable operation of one or more components or elements of the vehicle 10.

In some embodiments, the controller 505 may implement one or more actions or operations prior to determining control actions. For example, the controller 505 may analyze one or more states of the vehicle 10. As another example, the controller 505 may receive one or more inputs prior to determination of control actions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An autonomous refuse vehicle, comprising:
a chassis;
a body assembly supported by the chassis and defining a refuse compartment;
a drive motor coupled to the chassis and configured to drive one or more tractive elements to move the autonomous refuse vehicle;
a lift system movably coupled with the body assembly, the lift system configured to engage one or more refuse containers and to deposit contents of the one or more refuse containers into the refuse compartment; and
a controller electrically coupled with the drive motor and the lift system, the controller comprising one or more memory devices storing instructions thereon that, when executed by one or more processors, cause the one or more processors to:
receive, via a controller area network, from a first module coupled with the lift system, one or more first signals to indicate a first state of the lift system;
receive, via the controller area network, from a second module coupled with the drive motor, one or more second signals to indicate a second state of the drive motor; and
determine, based at least on the first state and the second state, a control action for the lift system with respect to a refuse container detected as being proximate to the body assembly.

2. The autonomous refuse vehicle of claim 1, wherein the lift system is controllable by a joystick of the autonomous refuse vehicle and by the controller, and wherein one or more inputs to the lift system, from the joystick, are configured to interrupt one or more second inputs provided to the lift system by the controller.

3. The autonomous refuse vehicle of claim 1, wherein the instructions further cause the one or more processors to:
receive, from the first module, an indication of a detection of the refuse container, wherein the first module is configured to detect and classify objects based on data captured by one or more cameras disposed on the autonomous refuse vehicle;
wherein the first state of the lift system reflects (i) the detection of the refuse container and (ii) a position of the lift system relative to the refuse container.

4. The autonomous refuse vehicle of claim 1, wherein the instructions further cause the one or more processors to:
monitor, based on subsequent information provided by at least one of the first module or the second module, changes to the first state and the second state; and
update, based on the changes to the first state and the second state, the control action for the lift system.

5. The autonomous refuse vehicle of claim 1, wherein the instructions further cause the one or more processors to:
prior to determination of the control action:
detect, based at least on the second state of the drive motor, that the autonomous refuse vehicle is moving;
receive an input to enable operation of an object detection system of the autonomous refuse vehicle;
execute, responsive to receipt of the input, one or more control signals to enable the object detection system; and
receive, from the object detection system, an indication of a detected location of the refuse container relative to the autonomous refuse vehicle.

6. The autonomous refuse vehicle of claim 1, wherein the instructions further cause the one or more processors to:
receive, from the first module, one or more updates to the first state of the lift system;
receive, from the second module, one or more updates to the second state of the drive motor;
detect, based on one or more sets of information collected by an object detection system of the autonomous refuse vehicle, the refuse container; and
execute, responsive to detection of the refuse container, the control action to collect the refuse container via the lift system.

7. The autonomous refuse vehicle of claim 6, wherein the object detection system is enabled, by the one or more processors, prior to detection of the refuse container, and wherein enablement of the object detection system occurs (i) while the autonomous refuse vehicle is moving and (ii) prior to movement of the lift system.

8. The autonomous refuse vehicle of claim 1, wherein the instructions further cause the one or more processors to:
implement, using the first state and the second state, logic to identify:
one or more instances to operate the lift system; and
one or more instances to adjust operation of the drive motor.

9. The autonomous refuse vehicle of claim 1, wherein the instructions further cause the one or more processors to:
execute the control action to collect the refuse container via the lift system;
receive, responsive to execution of the control action, an indication of a change to the first state;
determine, based at least on the change to the first state, that the lift system collected the refuse container; and
execute, responsive to determination that the lift system collected the refuse container, a second control action to move the lift system such that one or more contents of the refuse container are deposited within the refuse compartment of the autonomous refuse vehicle.

10. The autonomous refuse vehicle of claim 1, wherein the instructions further cause the one or more processors to:
provide, via a display device of the autonomous refuse vehicle, a user interface to present one or more of the first state, the second state, or an operation of the lift system that results from execution of the control action; and
execute, responsive to at least one input received via the user interface, the control action.

11. A control system for an autonomous refuse vehicle, the control system comprising:
one or more memory devices storing instructions thereon that, when executed by one or more processors, cause the one or more processors to:
receive, from a first module coupled with a lift system of the autonomous refuse vehicle, one or more first signals to indicate a first state of the lift system;
receive, from a second module coupled with a drive motor of the autonomous refuse vehicle, one or more second signals to indicate a second state of the drive motor; and
determine, based at least on the first state and the second state, a control action for the lift system with respect to a refuse container detected as being proximate to the autonomous refuse vehicle.

12. The control system of claim 11, wherein the lift system is controllable by a joystick of the autonomous refuse vehicle and by the control system, and wherein one or more inputs to the lift system, from the joystick, are configured to interrupt one or more second inputs provided to the lift system by the control system.

13. The control system of claim 11, wherein the instructions further cause the one or more processors to:
receive, from the first module, an indication of a detection of the refuse container, wherein the first module is configured to detect and classify objects based on data captured by one or more cameras disposed on the autonomous refuse vehicle;
wherein the first state of the lift system reflects (i) the detection of the refuse container and (ii) a position of the lift system relative to the refuse container.

14. The control system of claim 11, wherein the instructions further cause the one or more processors to:
monitor, based on subsequent information provided by at least one of the first module or the second module, changes to the first state and the second state; and
update, based on the changes to the first state and the second state, the control action for the lift system.

15. The control system of claim 11, wherein the instructions further cause the one or more processors to:
prior to determination of the control action:
detect, based at least on the second state of the drive motor, that the autonomous refuse vehicle is moving;
receive an input to enable operation of an object detection system of the autonomous refuse vehicle;
execute, responsive to receipt of the input, one or more control signals to enable the object detection system; and
receive, from the object detection system, an indication of a detected location of the refuse container relative to the autonomous refuse vehicle.

16. The control system of claim 11, wherein the instructions further cause the one or more processors to:
receive, from the first module, one or more updates to the first state of the lift system;
receive, from the second module, one or more updates to the second state of the drive motor;
detect, based on one or more sets of information collected by an object detection system of the autonomous refuse vehicle, the refuse container; and
execute, responsive to detection of the refuse container, the control action to collect the refuse container via the lift system.

17. The control system of claim 16, wherein the object detection system is enabled, by the one or more processors, prior to detection of the refuse container, and wherein enablement of the object detection system occurs (i) while the autonomous refuse vehicle is moving and (ii) prior to movement of the lift system.

18. A system, comprising:
an autonomous refuse vehicle, comprising:
a chassis;
a body assembly supported by the chassis and defining a refuse compartment;
a drive motor coupled to the chassis and configured to move the autonomous refuse vehicle; and
a lift system movably coupled with the body assembly, the lift system configured to grab one or more refuse containers; and
a controller electrically coupled with the drive motor and the lift system, the controller comprising one or more memory devices storing instructions thereon that, when executed by one or more processors, cause the one or more processors to:
receive, via a controller area network, from a first module coupled with the lift system, one or more first signals to indicate a first state of the lift system;
receive, via the controller area network, from a second module coupled with the drive motor, one or more second signals to indicate a second state of the drive motor; and
determine, based at least on the first state and the second state, a control action for the lift system with respect to a refuse container detected as being proximate to the autonomous refuse vehicle.

19. The system of claim 18, wherein the lift system is controllable by a joystick of the autonomous refuse vehicle and by the controller, and wherein one or more inputs to the lift system, from the joystick, are configured to interrupt one or more second inputs provided to the lift system by the controller.

20. The system of claim 18, wherein the instructions further cause the one or more processors to:
receive, from the first module, an indication of a detection of the refuse container, wherein the first module is configured to detect and classify objects based on data captured by one or more cameras disposed on the autonomous refuse vehicle;
wherein the first state of the lift system reflects (i) the detection of the refuse container and (ii) a position of the lift system relative to the refuse container.
